(19) United States
(12) Patent Application Publication
(10) Pub. No.: US 2025/0309278 A1
(43) Pub. Date: Oct. 2, 2025

(54) TRIFUNCTIONAL GRAPHENE-SANDWICHED HETEROJUNCTION-EMBEDDED LAYERED LATTICE CATALYST WITH HIGH ACTIVITY AND STABILITY FOR ZN-AIR BATTERY-DRIVEN WATER SPLITTING

(71) Applicant: KOREA ADVANCED INSTITUTE OF SCIENCE AND TECHNOLOGY, Daejeon (KR)

(72) Inventors: Jeung Ku KANG, Daejeon (KR); Dong Won KIM, Daejeon (KR); Jihoon KIM, Daejeon (KR); Jong Hui CHOI, Daejeon (KR); Do Hwan JUNG, Daejeon (KR)

(21) Appl. No.: 18/794,048

(22) Filed: Aug. 5, 2024

(30) Foreign Application Priority Data
Mar. 29, 2024 (KR) 10-2024-0043532

(51) Int. Cl. H01M 4/86; C25B 1/04; C25B 11/091; H01M 4/90; H01M 12/08

(52) U.S. Cl. CPC H01M 4/8657; C25B 1/04; C25B 11/091; H01M 4/9083; H01M 12/08

(57) ABSTRACT

The present disclosure relates to a trifunctional catalyst, a method of the trifunctional catalyst, and a water splitting system using the trifunctional catalyst. The water splitting system according to embodiments of the present disclosure can be applied to energy storage and conversion by using characteristics of three types of catalytic reactions (oxygen evolution reaction (OER), oxygen reduction reaction (ORR), and hydrogen evolution reaction HER)) and can serve as a self-powered clean hydrogen production system at the same time.

### CROSS-REFERENCE TO RELATED APPLICATION

This application claims the benefit under 35 U.S.C. 119(a) of Korean Patent Applications No. 10-2024-0043532 filed on Mar. 29, 2024 in the Korean Intellectual Property Office, the entire disclosures of which are incorporated herein by reference for all purposes.

### TECHNICAL FIELD

The present disclosure relates to a trifunctional graphene-sandwiched heterojunction catalyst, a method of preparing the same, and a water splitting system using the same.

### BACKGROUND

The escalating demand for sustainable energy consumption and the need to address environmental pollution are driving the exploration of eco-friendly, low-cost, and highly efficient energy storage and conversion systems. Notably, a development of a system which is a union of a rechargeable aqueous metal-air battery and an alkaline water-splitting cell has gained considerable attention owing to producing a high-energy-density fuel and having a nonflammable characteristic and their potentials in the clean hydrogen fuel generation system. The electrocatalytic reactions taking an important role in the two systems mainly rely on three distinct reactions: oxygen reduction reaction (ORR), oxygen evolution reaction (OER), and hydrogen evolution reaction (HER). Currently, the catalyst material with the best performance is a catalyst based on noble metals (such as Pt, Ru, Ir etc.), however, most noble metal catalysts do not show effective performance in one or more catalytic reactions and have limitation of having low lifespans. Consequently, there is a need for research and development on catalysts that exhibit effective properties for power of a rechargeable aqueous metal-air battery and for water splitting.

### PRIOR ART LITERATURE

KR Patent Laid-open Publication No. 10-2023-0026606.

### SUMMARY

The present disclosure provides a trifunctional catalyst, a synthesis method of the same, and a water splitting system using the same.

However, problems to be solved by the present disclosure are not limited to the above-described problems. Although not described herein, other problems to be solved by the present disclosure can be clearly understood by a person with ordinary skill in the art from the following description.

A first aspect of the present disclosure provides a trifunctional catalyst comprising a polyhedral Co₃S₄ layer, a first MoS₂ layer and a second MoS₂ layer on the Co₃S₄ layer, and a graphene layer between the first MoS₂ and the second MoS₂ layer.

A second aspect of the present disclosure provides a synthesis method of the trifunctional catalyst above, comprising a process (a) of growing ZIF-67 on a surface of graphene oxide(GO); a process (b) of sulfurizing the ZIF-67 to obtain a G-Co₃S₄ structure containing the graphene oxide and a Co₃S₄ layer; and a process (c) of growing a MoS₂ layer on the G-Co₃S₄ structure to obtain the trifunctional catalyst of the first aspect.

A third aspect of the present disclosure provides an air electrode for a metal-air battery comprising the trifunctional catalyst according to the first aspect.

The fourth aspect of the present disclosure provides a metal-air battery comprising an air electrode of the third aspect; an anode containing a metal; and an electrolyte.

The fifth aspect of the present disclosure provides a water splitting system comprising the trifunctional catalyst, wherein the trifunctional catalyst comprises the polyhedral Co₃S₄ layer; the first MoS₂ layer and the second MoS₂ layer located on the CO₃S₄ layer; and the graphene layer located between the first MoS₂ layer and the second MoS₂ layer.

A trifunctional catalyst according to embodiments of the present disclosure has a hollow structure and contains an electrolyte and an electrochemical reaction intermediate product, so that oxygen and hydrogen gases are easily evolve and transferred.

The trifunctional catalyst according to embodiments of the present disclosure can show high activity for hydrogen evolution reaction (HER).

The trifunctional catalyst according to embodiments of the present disclosure has a long lifetime and high stability.

The cell voltage of a water splitting system according to embodiments of the present disclosure is maintained constant.

A method of obtaining a trifunctional catalyst according to embodiments of the present disclosure is performed through a one-pot process, and is performed rapidly with less energy than a conventional method of obtaining a catalyst.

The method of obtaining a trifunctional catalyst according to embodiments of the present disclosure is a safe and simple process which does not use much energy and any toxic materials.

The method of obtaining a trifunctional catalyst according to embodiments of the present disclosure uses next-generation catalyst materials based on earth-abundant transition metal chalcogenide, and allows for an economical process.

The water splitting system according to embodiments of the present disclosure can be applied to energy storage and conversion by using characteristics of three types of catalytic reactions (oxygen evolution reaction (OER), oxygen reduction reaction (ORR), and hydrogen evolution reaction HER)) and can serve as a self-powered clean hydrogen production system at the same time.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different figures indicates similar or identical items.

FIG. 1A to FIG. 1F are schematic views showing a method of synthesizing a G-SHELL according to an embodiment of the present disclosure, FIG. 1G is a schematic view showing a hollow structure of G-SHELL according to an embodiment of the present disclosure, FIG. 1H is a schematic view showing a heterojunction of G-SHELL of an embodiment of the present disclosure, FIG. 1I shows energy levels of CO₃S₄ and MoS₂/Co₃S₄ of an embodiment of the present disclosure, and FIG. 1J is a schematic view showing a water splitting system of an embodiment of the present disclosure.

FIG. 2A and FIG. 2B are transmission electron microscopy (TEM) images of G-SHELL (scale bar: 20 nm and 5 nm) of an example of the present disclosure, FIG. 2C to FIG. 2E are high-resolution TEM (HRTEM) images of G-SHELL showing (002) layer of a graphene, (004) layer of a sandwiched MoS₂-graphene, and (311) layer of a Co₃S₄, respectively, according to an example of the present disclosure, and the insets of FIG. 2C to FIG. 2E show fast Fourier transform (FFT) patterns thereof.

FIG. 3A and FIG. 3B show XANES (X-ray absorption near edge structure) spectra and Fourier-transformed EXAFS (extended X-ray absorption fine structure) spectra, respectively, of Mo, MoO₃, MoS₂, Co₃S₄/MoS₂, and G-SHELL according to an example of the present disclosure, and FIG. 3C shows a graph of wavelet transform with k2-weighted Fourier transform of Co K-edge and Mo K-edge according to an example of the present disclosure.

FIG. 4A to FIG. 4H show transmission electron microscopy-energy dispersive x-ray spectroscopy (STEM-EDS) images of Co₃S₄/MoS₂ according to an example of the present disclosure.

FIG. 5A to FIG. 5C show sample X-ray diffraction (XRD) patterns; N₂ adsorption-desorption isotherms; and differential pore volume curves of Co₃S₄, Co₃S₄/MoS₂, G-Co₃S₄ and G-SHELL, respectively, according to an example of the present disclosure.

FIG. 6A shows Raman spectra of Co₃S₄, Co₃S₄/MoS₂, G-Co₃S₄ and G-SHELL (Raman shift range of 200 cm⁻¹ to 1,000 cm⁻¹ includes in-plane and out-plane vibration modes of MoS₂ and formation of Co—S—Mo bonds) according to an example of the present disclosure, FIG. 6B shows an ultraviolet photoelectron spectroscopy (UPS) spectra of a secondary electron cutoff region for measurement of work function (WF) according to an example of the present disclosure, FIG. 6C shows a valence band regions for determination of valence band maximum (VBM) according to an example of the present disclosure, and FIG. 6D is a diagram of energy levels calculated by linear extrapolation of leading UPS edges according to an example of the present disclosure.

FIG. 7A to FIG. 7D are X-ray photoelectron spectroscopy (XPS) scanning graphs of Co₃S₄, Co₃S₄/MoS₂, G-Co₃S₄, and G-SHELL according to an example of the present disclosure.

FIG. 8 shows XPS spectra of S 2p according to an example of the present disclosure.

FIG. 9 shows XPS spectra of Co 2p according to an example of the present disclosure.

FIG. 10 shows XPS spectra of Mo 3d according to an example of the present disclosure.

FIG. 11A shows an ORR polarization curve at 1,600 rpm in an O₂-saturated 0.1 M KOH solution, and the inset shows a CV curve of G-SHELL in the O₂-saturated 0.1 M KOH solution according to an example of the present disclosure, and FIG. 11B shows an ORR polarization curve of G-SHELL at various revolutions per minute (rpm), and the inset shows a K-L plot (ω^{-1/2} vs j⁻¹; ω and j denote the angular rotational speed and the current density at a specific voltage, respectively) according to an example of the present disclosure.

FIG. 12A to FIG. 12C show rotating disk electrode (RDE) data of Co₃S₄, Co₃S₄/MoS₂ and G-Co₃S₄ according to an example of the present disclosure, and FIG. 12D to FIG. 12F show K-L plots of Co₃S₄, Co₃S₄/MoS₂ and G-Co₃S₄ according to an example of the present disclosure.

FIG. 13 shows an ORR performance histogram of inception voltage (Eₒₙₛₑₜ), half-wave potential (E_{1/2}) and kinetic current (jₖ) according to an example of the present disclosure.

FIG. 14A to FIG. 14C show OER polarization curves for comparison with RuO₂ at 1,600 rpm in 1 M KOH, a Tafel slope corresponding thereto, and electric double layer capacitance (EDLC) graphs calculated from the slopes of 1/2 Δj-scan rate plots, respectively, according to an example of the present disclosure.

FIG. 15A to FIG. 15C show a HER polarization curves for comparison with Pt/C at 1,600 rpm in 1 M KOH, a Tafel slopes corresponding thereto, and a stability test graphs of G-SHELL and noble metals in alkaline conditions, respectively, according to an example of the present disclosure.

FIG. 16A and FIG. 16B are TEM images of G-HELL after immersion in 1 M KOH for 10 days according to an example of the present disclosure.

FIG. 17A and FIG. 17B show polarization curves during charge and discharge at 10 mV s⁻¹, and a graph of high discharge current density versus voltage and corresponding power density, respectively, according to an example of the present disclosure.

FIG. 18A to FIG. 18E are graphs of rate stability of a Zn-air battery in ambient conditions using a 6 M KOH+0.2 M Zn(OAC)₂ electrolyte for stack cells according to an example of the present disclosure, and specifically, FIG. 18A to FIG. 18E show speed stability behaviors of Co₃S₄, Co₃S₄/MoS₂, G-Co₃S₄ and G-SHELL, respectively, and the inset graphs show round-trip efficiency.

FIG. 19 is a voltage graph of a G-SHELL-based Zn-air battery in ambient conditions using a 6 M KOH+0.2 M Zn(OAC)₂ electrolyte for stack cells (unit of applied current density: mA cm⁻²) according to an example of the present disclosure.

FIG. 20 is a graph of long-term cyclability test of ZABs with various current densities and cycle times according to an example of the present disclosure.

FIG. 21A to FIG. 21C show typical discharge curves under continuous consumption of zinc metal (the specific capacity is normalized by the mass of consumed Zn), an example of a Zn-air battery-driven water splitting cell, and a diagram showing an electrolysis process driven by the Zn-air battery-driven water splitting cell containing a single trifunctional G-SHELL electrocatalyst for HER, OER or ORR, respectively, according to an example of the present disclosure.

FIG. 22A to FIG. 22C show water splitting performances of CO₃S₄, Co₃S₄/MoS₂, G-Co₃S₄, G-SHELL, Pt/C and RuO₂ with respect to a hydrophilic carbon substrate (1 cm×1 cm) in an O₂-saturated 1 M KOH solution according to an example of the present disclosure, and specifically, FIG. 22A and FIG. 22B show LSV graphs of HER and OER, respectively, and FIG. 22C shows EIS graphs at 1.56 V.

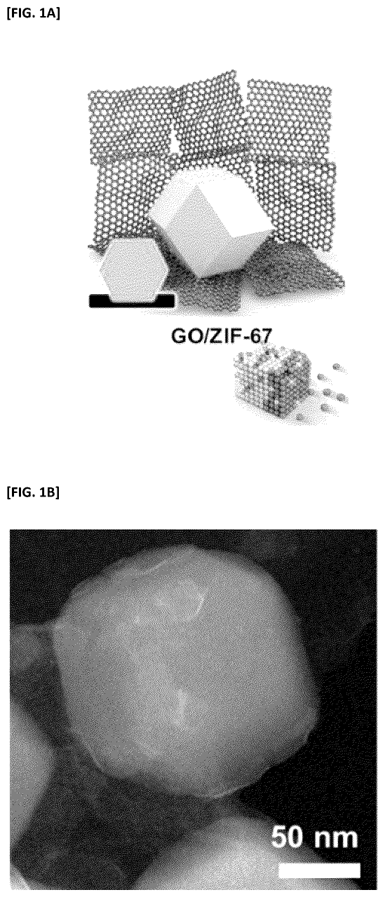

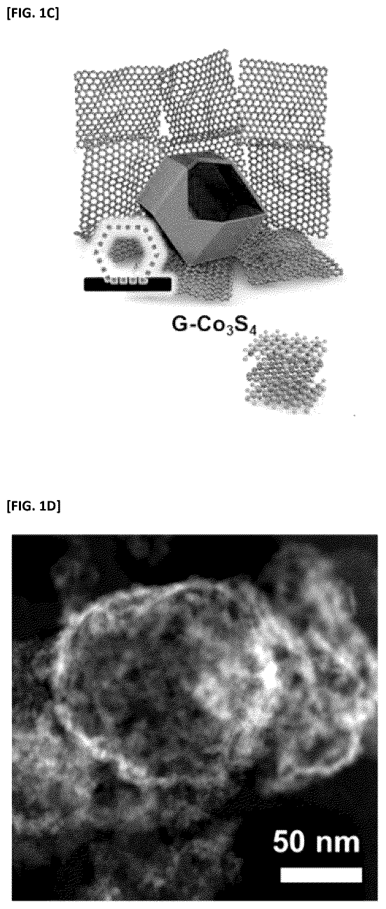

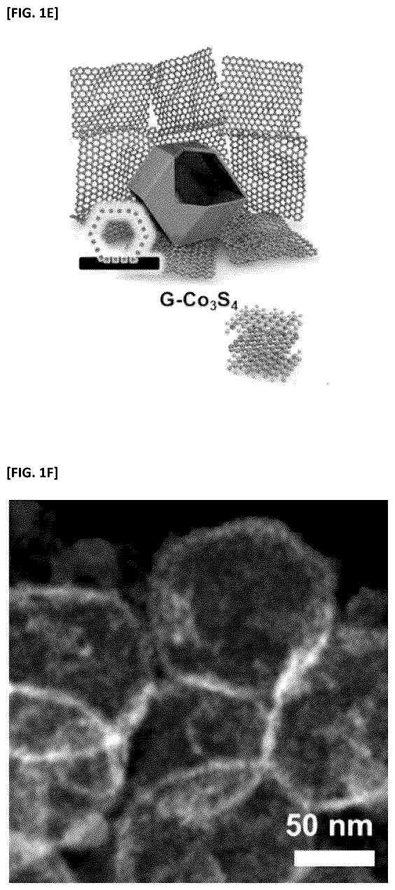

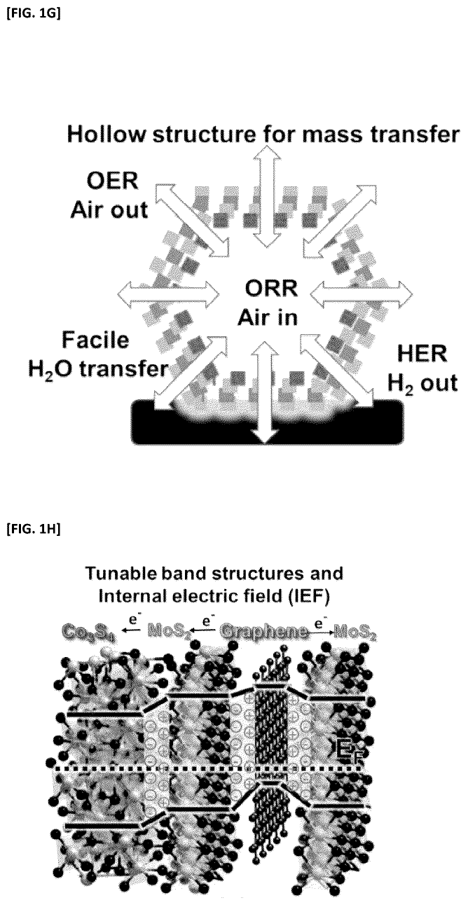

### DETAILED DESCRIPTION

Hereafter, embodiments of the present disclosure will be described in detail with reference to the accompanying drawings. However, it is to be noted that the present disclosure is not limited to the embodiments but can be embodied in various other ways. Also, the accompanying drawings are provided to help easily understand the embodiments of the present disclosure and the technical conception described in the present disclosure is not limited by the accompanying drawings. In the drawings, parts irrelevant to the description are omitted for the simplicity of explanation, and the size, form and shape of each component illustrated in the drawings can be modified in various ways. Like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through this whole specification, a phrase in the form “A and/or B” means “A or B, or A and B”.

Hereinafter, embodiments and examples of the present disclosure will be described in detail with reference to the accompanying drawings. However, the present disclosure may not be limited to the following embodiments, examples, and drawings.

A first aspect of the present disclosure provides a trifunctional catalyst comprising: a polyhedral Co₃S₄ layer; a first MoS₂ layer and a second MoS₂ layer located on the Co₃S₄ layer and a graphene layer located between the first MoS₂ layer and the second MoS₂ layer.

In an embodiment of the present disclosure, the trifunctional catalyst may have a diameter of from about 90 nm to about 100 nm, but may not be limited thereto.

In an embodiment of the present disclosure, the trifunctional catalyst may have a hollow structure.

In an embodiment of the present disclosure, heterojunctions may be formed, respectively, between the Co₃S₄ layer and the first MoS₂ layer, between the first MoS₂ layer and the graphene layer, and between the graphene layer and the second MoS₂ layer.

In an embodiment of the present disclosure, the trifunctional catalyst may be used for an oxygen evolution reaction (OER), a hydrogen evolution reaction (HER), and/or an oxygen reduction reaction (ORR).

A second aspect of the present disclosure provides a method of obtaining a trifunctional catalyst, comprising: a process (a) of growing ZIF-67 on a surface of graphene oxide; a process (b) of sulfurizing the ZIF-67 to obtain a G-Co₃S₄ structure containing the graphene oxide and the Co₃S₄ layer; and a process (c) of growing a MoS₂ layer on the G-Co₃S₄ structure to obtain the trifunctional catalyst of the first aspect.

Detailed descriptions of the second aspect of the present disclosure, which overlap with those of the first aspect of the present disclosure, are omitted hereinafter, but the descriptions of the first aspect of the present disclosure may be identically applied to the second aspect of the present disclosure, even though they are omitted hereinafter.

In an embodiment of the present disclosure, the method of obtaining a trifunctional catalyst may be performed through a one-pot process.

In an embodiment of the present disclosure, the process (b) may be performed at a temperature of from about 50° C. to about 200° C., but may not be limited thereto. In the embodiment of the present disclosure, the process (b) maybe performed in the temperature range of about 50° C. to about 200° C., about 50° C. to about 180° C., about 50° C. to about 160° C., about 50° C. to about 140° C., about 70° C. to about 200° C., about 70° C. to about 180° C., about 70° C. to about 160° C., about 70° C. to about 140° C., about 90° C. to about 200° C., about 90° C. to about 180° C., about 90° C. to about 160° C., about 90° C. to about 140° C., about 110° C. to about 200° C., about 110° C. to about 180° C., about 110° C. to about 160° C., about 110° C. to about 140° C., but may not be limited thereto. In an embodiment of the present disclosure, the process (b) may be performed, most preferably, at about 120° C.

In an embodiment of the present disclosure, the process (b) may be performed for from about 1 hour to about 7 hours, but may not be limited thereto. In an embodiment of the present disclosure, the process (b) maybe performed for about 1 hour to about 7 hours, about 1 hour to about 6 hours, about 1 hour to about 5 hours, about 2 hours to about 7 hours, about 2 hours to about 6 hours, about 2 hours to 5 hours, about 3 hours to about 7 hours, about 3 hours to about 6 hours, about 3 hours to about 5 hours, but may not be limited thereto. In an embodiment of the present disclosure, the process (b) may be performed, most preferably, for about 4 hours.

In an embodiment of the present disclosure, the process (c) may be performed at a temperature of from about 100° C. to about 300° C., but may not be limited thereto. In and embodiment of the present disclosure, the process (c) maybe performed in the temperature range of about 100° C. to about 300° C., about 100° C. to about 280° C., about 100° C. to about 260° C., about 100° C. to about 240° C., about 100° C. to about 220° C., about 120° C. to about 300° C., about 120° C. to about 280° C., about 120° C. to about 260° C., about 120° C. to about 240° C., about 120° C. to about 220° C., about 140° C. to about 300° C. 140° C. to about 280° C., 140° C. to about 260° C., 140° C. to about 240° C., 140° C. to about 220° C., 160° C. to about 300° C., 160° C. to about 280° C., 160° C. to about 260° C., 160° C. to about 240° C., 160° C. to about 220° C., 180° C. to about 300° C., 180° C. to about 280° C., 180° C. to about 260° C., 180° C. to about 240° C., 180° C. to about 220° C., but may not be limited thereto. In an embodiment of the present disclosure, the process (c) may be performed, most preferably, at about 200° C.

In an embodiment of the present disclosure, the process (c) may be performed for from about 5 hours to about 15 hours, but may not be limited thereto. In an embodiment of the present disclosure, the process (c) maybe performed for about 5 hours to about 15 hours, about 5 hours to about 13 hours, about 5 hours to about 11 hours, about 5 hours to about 9 hours, about 7 hours to about 15 hours, about 7 hours to about 13 hours, about 7 hours to about 11 hours, about 7 hours to about 9 hours but may not be limited thereto. In an embodiment of the present disclosure, the process (c) may be performed, most preferably, for about 8 hours.

A third aspect of the present disclosure provides an air electrode for a metal-air battery, comprising the trifunctional catalyst of the first aspect.

Detailed descriptions of the third aspect of the present disclosure, which overlap with those of the first and the second aspect of the present disclosure, are omitted hereinafter, but the descriptions of the first and the second aspect of the present disclosure may be identically applied to the third aspect of the present disclosure, even though they are omitted hereinafter.

In an embodiment of the present disclosure, the metal-air battery may be a zinc-air battery, an aluminum-air battery, a magnesium-air battery, or a lithium-air battery.

A fourth aspect of the present disclosure provides a metal-air battery comprising; an electrode of the third aspect; an anode containing a metal; and an electrolyte.

Detailed descriptions of the fourth aspect of the present disclosure, which overlap with those of the first to the third aspect of the present disclosure, are omitted hereinafter, but the descriptions of the first to the third aspect of the present disclosure may be identically applied to the fourth aspect of the present disclosure, even though they are omitted hereinafter.

A fifth aspect of the present disclosure provides a water splitting system comprising a trifunctional catalyst which comprises: a polyhedral Co₃S₄ layer; a first MoS₂ layer and a second MoS₂ layer located on the Co₃S₄ layer; and a graphene layer located between the first MoS₂ layer and the second MoS₂ layer.

Detailed descriptions of the fifth aspect of the present disclosure, which overlap with those of the first to the fourth aspect of the present disclosure, are omitted hereinafter, but the descriptions of the first to the fourth aspect of the present disclosure may be identically applied to the fifth aspect of the present disclosure, even though they are omitted hereinafter.

In an embodiment of the present disclosure, a power supply device used in the water splitting system may be a metal-air battery (by way of non-limiting example, a zinc-air battery) comprising the air electrode comprising the catalyst.

In an embodiment of the present disclosure, an anode and/or a cathode of the water splitting system may contain the catalyst.

In an embodiment of the present disclosure, the water splitting may be performed in alkaline conditions.

In an embodiment of the present disclosure, the water splitting system comprises a power supply device including a metal-air battery, an anode for water splitting, a cathode for water splitting, and an electrolyte, and at least one selected from an air electrode of the metal-air battery, the anode for water splitting, and the cathode for water splitting may contain the catalyst.

In an embodiment of the present disclosure, when the air electrode of the metal-air battery, the anode for water splitting, and the cathode for water splitting contain the catalyst, an oxygen reduction reaction, an oxygen evolution reaction, and a hydrogen evolution reaction may occur in the air electrode, the anode for water splitting, and the cathode for water splitting, respectively.

Hereinafter, the present disclosure will be explained in more detail with reference to Examples. However, the following Examples are illustrative only for better understanding of the present disclosure but do not limit the present disclosure.

### EXAMPLES

### <Chemicals>

Graphite powder sized 300 mesh was obtained from Alfa Aesar Co. Ltd., sulfuric acid, phosphoric acid, hydrogen peroxide, and hydrochloric acid were purchased form Duksan Co. Ltd., Ketjenblack® EC was supplied Mitubishi Co. Ltd., Nafion™ solution, 2-Methylimidazole, Potassium permanganate, Cobalt (II) nitrate hexahydrate, Sodium molybdate dihydrate, Thioacetamide, Isopropanol, Anhydrous Ethanol, Anhydrous Methanol were supplied by Sigma-Aldrich.

### Example 1

### Synthesis of Graphene Oxide (GO) Solution

2 g of graphite powder and 40 ml of concentrated sulfuric acid (H₂SO₄) were mixed and sonicated for 4 hours for pretreatment. Then, the graphite powder was washed with deionized water and dried in a vacuum oven at 60° C. overnight for further use and the dried powder was added to 200 ml of concentrated H₂SO₄ (95%) and 36 ml of phosphoric acid (H₃PO₄, 85%). 12 g of potassium permanganate (KMnO₄) was slowly added to the mixture while stirring and the temperature was kept below 100° C. The mixture was stirred for 24 hours, and deionized water was carefully added to dilute the acidity. The mixture was kept in an ice bath throughout this process to keep the temperature below 50° C., then the mixture was additionally stirred for 24 hours. By adding hydrogen peroxide, the mixture changed the color form dark brown to a bubbly light yellow. The mixture was washed with a 0.1 M hydrochloric acid (HCl) aqueous solution twice to get rid of metal ions and washed with deionized water for 3 times to remove the remaining traces of acid. Afterward, the mixture was sonicated for 4 hours for exfoliation and centrifuged to remove any heavy particles to obtain a GO solution. The concentration of the mixture was controlled at 4 mg mL- and stored under ambient conditions.

### Example 2

### Synthesis of ZIF-67 and ZIF-67/GO

1 mmol of cobalt nitrate hexahydrate (Co(NO₃)₂·6H₂O) and 3 mmol of 2-Methylimiazole were dissolved in different 10 mL methanol, then the solution was vigorously stirred until powder is fully dissolved into clear solution. Then, the Solution of 2-Methlylimidazole was added into the cobalt nitrate hexahydrate solution to grow ZIF-67 on a GO surface. To analyze an adequate amount of ZIF-67, FT-IR spectra of various mixtures of Co²⁺/GO solutions were analyzed. As a mixture of two solutions, the purple precipitates were formed. ZIF-67/GO was obtained by following the procedure above, except for the dispersion of a certain amount of graphene oxide dispersed methanol solution. ZIF-67 and ZIF-67/GO were washed by centrifugation for 3 times against methanol and the solution was dried under vacuum oven overnight.

### Example 3

Synthesis of Co₃S₄, Co₃S₄/MoS₂, G-CO₃S₄, and G-SHELL

To obtain Co₃S₄ and G-Co₃S₄, 25 mg of ZIF-67 and ZIF-67/GO were dispersed with 10 mL anhydrous ethanol and stirred until they were homogeneously dispersed. Then, separately prepared 25 mg of Thioacetamide dissolved in 10 mL of ethanol solution were added into ZIF-67 and ZIF-67/GO solution and the mixture solution was mixed and stirred for 30 minutes. The mixture solution was sealed into a 25 mL Teflon-lined stainless autoclave and the mixture was heated at 120° C. for 4 hours. A Black-colored power was recovered by washing with deionized water and ethanol for multiple times with centrifuge, then obtained power was dried in a vacuum oven overnight. G-SHELL was obtained by adding 25 mg of Sodium molybdate dihydrate and further heating in 200° C. for 8 hours to introduce MoS₂ onto the Co₃S₄ surface. During the solvothermal step, due to the difference in diffusivity of S and Co, Kirkendall effect has made the G-ZIF-67 to become a hollow structure.

### Result

### <Analysis Method of G-SHELL>

The powder X-ray diffraction (XRD) analysis was done using Rigaku (Japan)'s SmartLab X-ray diffractometer with Cu-Kα radiation of 1200 W (40 kV, 30 mA). The range of angle (2θ) was set to be 5-80° at ambient temperature. Scanning electron microscopy (SEM) analysis were carried out using Magellan400 (FEI company). Transmission electron microscopy (TEM) images were obtained from JEM-ARM200F (JEOL, Japan), which an operation voltage of 200 kV. Elemental distributions were examined using energy-dispersive X-ray microscopy of the same TEM device. For the X-ray photoelectron spectroscopy (XPS) analysis, Thermo VG Scientific K-alpha spectrometer (Thermo Scientific, USA) with Al-Kα radiation at 350 W (3 mA) was used. N₂ adsorption isotherm data were collected using Qudrasorp (Quantachrome) device. Pore size distribution was analyzed using density functional theory (DFT) method. X-ray absorption at near edge structure (XANES) and extended X-ray absorption fine structure (EXAFS) analysis were carried out with Sigray QuantumLeap-H2000. Energy range of 7650-7950 eV was selected to analyze cobalt and 19,950-20,150 eV was selected for the analysis of Mo. EPR, Contact angle.

### <Electrochemical Measurement>

The electrochemical oxygen reduction reaction (ORR) measurements were conducted using the Biologic SP-300 potentiostat with a RRDE-3A device. A standard three-electrode electrochemical cell was constructed using rotating disk electrode (RDE) for working electrode (geometric area=0.0707 cm²), Pt wire for counter electrode, and Hg/HgO electrode as reference electrode, respectively. 0.1 M KOH was used as electrolyte for the analysis of ORR. Catalyst ink was prepared by dispersing 4 mg of catalyst and 1 mg of Ketjen black (EC 600 JD) in a solution containing 950 μL of Isopropyl alcohol (IPA) and 50 μL of 5 wt % Nafion solution. The mixed solution was sonicated for over than 30 min for homogeneous dispersion. Afterward, 4 μL of catalyst ink was dropped onto the rotating disk electrode surface and dried. The measured voltage was converted to a reversible hydrogen electrode (RHE) using the following equation, E(vs. RHE)=E(vs. Hg/HgO)+E° (vs. Hg/HgO)+0.0592 pH. The electrolyte was purged with pure O₂ gas for over than 30 minutes. Linear sweep voltammetry (LSV) analysis were conducted at a scan rate of 10 mV s⁻¹. The electrochemical active surface area (ESCA) was calculated using the double-layer capacitance (C_{dl}), which was determined using the different scan rates of cyclic voltammetry. The LSV curves on RDE with different rotating speeds (400, 800, 1200, 1600, 2000, 2400 rpm) were obtained during the ORR test. The corresponding electron transfer number (n) was calculated based on the Koutecky-Levich (K-L) equation:

$$\frac{1}{J} = \frac{1}{{J}_{L}} + \frac{1}{{J}_{K}} = \frac{1}{B {ω}^{1 / 2}} + \frac{1}{{J}_{K}} \qquad ( S 1 )$$

$$B = 0.62 {{nFC}_{0} ( {D}_{0} )}^{2 / 3} {v}^{- 1 / 6} \qquad ( S 2 )$$

In the S1 and S2, J_{L} is the diffusion-limited current density, J_{K} is the kinetic current density, ω is the angular velocity, n is the transfer number of electron, F is the Faraday constant (96,485 C mol⁻¹), D₀ is the diffusion coefficient of O₂ (1.9×10−5 cm² s⁻¹), C₀ is the concentration of O₂ (1.2×10⁻⁶ mol cm⁻³), and v is the viscosity of the electrolyte (assumed to be 0.01 cm² s⁻¹).

The oxygen evolution reaction (OER) and hydrogen evolution reaction (HER) were conducted at a rotation speed of 1600 rpm and a scan rate of 5 mV s⁻¹ in O₂-saturated alkaline media of 1 M KOH. The overpotential (η) of OER was calculated by η=ERHE−1.23 V. LSV curves were corrected by 85% iR compensation.

### <Zn-Air Battery Performance Evaluation>

A polished and washed Zn plate (250 μm thick) was used as an anode. The catalyst ink was dropped onto a of carbon paper with PTFE coated gas-diffusion layer and used as cathode. The mass loading of catalyst was 1 mg cm⁻². An aqueous solution containing 6 M KOH and 0.2 M Zn(OAC)₂ was used as an electrolyte for the Zn-air battery. Ni foam was washed with 3 M HCl and distilled water and the Ni foam was used as a current collector to collect current and to support the gas diffusion layer. For the measurement of power density, charging process was initially conducted from open circuit voltage (OCV) to 2.2 V with a scan rate of 10 mV s⁻¹, and the discharge process was conducted with the same scan rate until the current density have reached 400 mA cm⁻². For comparison of the performance, 20 wt % Pt/C+RuO₂ with a mass ratio of 1:1 was used as reference. The specific capacity of the Zn-air battery was calculated based on the amount of Zn consumption.

### Result 1. Scanning Electron Microscopy (SEM) Analysis

The scanning electron microscopy (SEM) images of ZIF-67 and G-ZIF-67 clearly show that ZIF-67 has a large particle size of 974 nm, whereas G-ZIF-67 has a significantly smaller particle size of 151 nm. The particle size decreased as the synthesis procedure progressed for the samples grown on GO; however, the opposite phenomenon was observed for the synthesis procedure of Co₃S₄/MoS₂. The median particle diameters for G-ZIF-67, G-Co₃S₄ and G-Co₃S₄/MoS₂ were 151, 111, and 96 nm, respectively. G-ZIF-67 has a sheet-like morphology with a thickness of less than 300 nm. Also, the addition of GO provided sufficient nucleation sites for ZIF-67 growth, allowing a smaller median particle size compared to pristine ZIF-67.

### Result 2. Transmission Electron Microscopy (TEM) Analysis

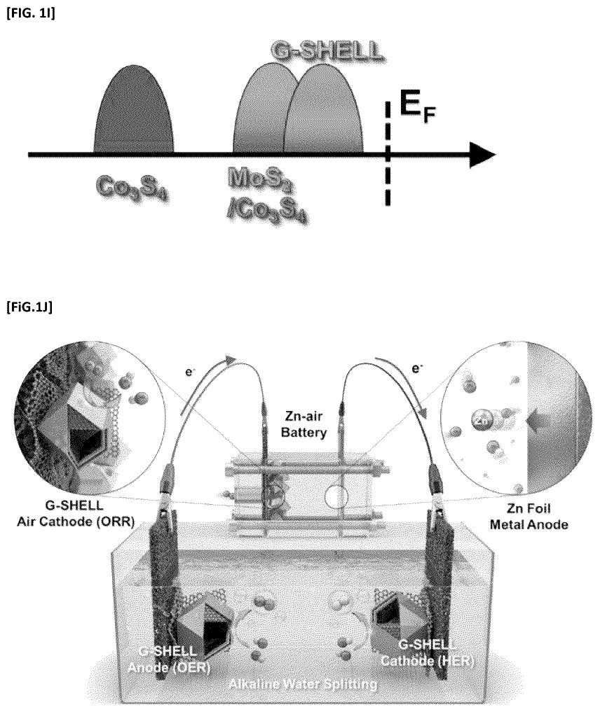

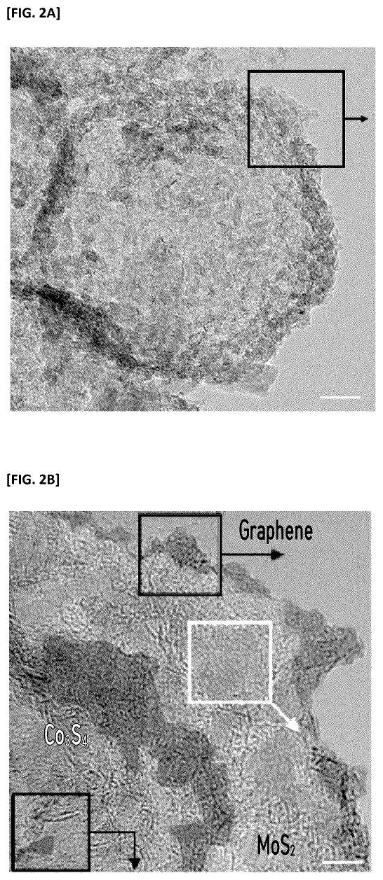

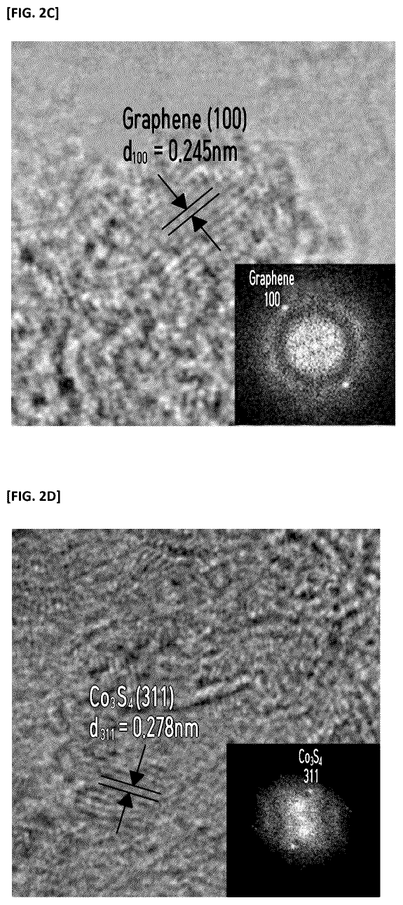

The transmission electron microscopy (TEM) image (FIG. 2A) reveals that a hollow G-SHELL structure has the inner core appeared bright and the outer shell appeared dark. The d-spacings of the graphene (100) plane (FIG. 2B), Co₃S₄(311) plane (FIG. 2C), and sandwiched MoS₂-graphene (002) interlayer (FIG. 2D) were obtained by analysing high-resolution TEM (HRTEM) images. Because the d-spacing value of 0.52 nm is nowhere near the (002) planar distance of MoS₂ (0.62 nm) or graphene (0.33 nm) but somewhere in between, it can be deduced that the d-spacing of 0.52 nm is the value of the MoS₂-graphene interlayer distance. Moreover, this value directly corresponded to the 002 peak of the X-ray diffraction (XRD) pattern at 20=17° (FIG. 2E), whereas the peak (002) appeared below 20=15° (JCPDS 37-1492) for bare 2H MoS₂, indicating a clear difference in the Van Der Waals bonding behaviour between MoS₂ and G-SHELL. Since the XRD peak corresponding to the (002) peak of bare MoS₂ (20=14.3°) was not detected but the shifted peak was detected for G-SHELL, subsequent amount of MoS₂ layers in the G-SHELL seems to contain sandwiched graphene layers. Other evidence included the multiple peaks for the (002) plane, including (001) and (004) peaks, in the XRD pattern (20=9.5° and 20=34.2°). Furthermore, the presence of a heterojunction between Co₃S₄ and the MoS₂-graphene sandwich could be confirmed using the selected-area electron diffraction (SAED) patterns of HRTEM images.

### Result 3. Inductively Coupled Plasma Mass Spectrometry (ICP-MS) and X-Ray Absorption at Near Edge Structure (XANES) Analysis

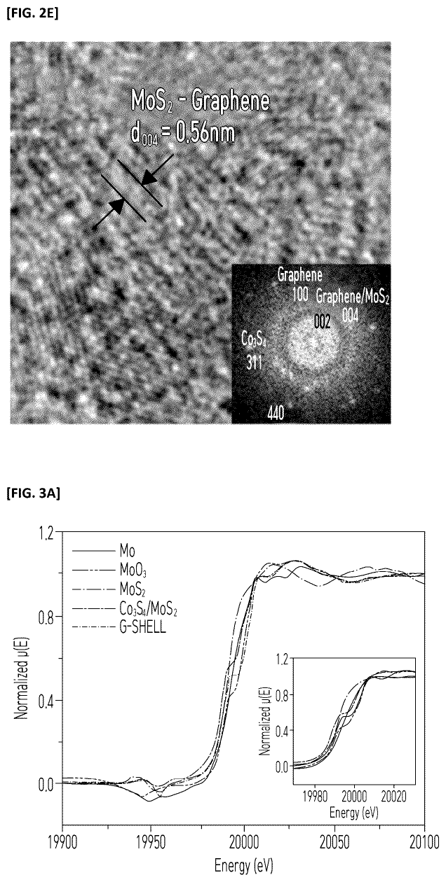

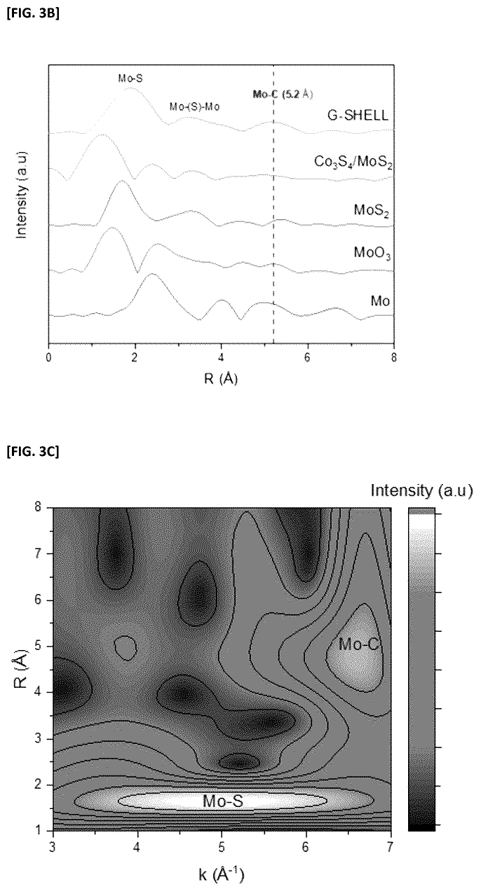

An inductively coupled plasma mass spectrometry (ICP-MS) analysis revealed that the atomic percentage of Mo in G-SHELL was significantly higher than that in the sample without graphene, namely, Co₃S₄/MoS₂. For precise identification of the bonding nature around Mo and Co, X-ray absorption structure including X-ray absorption at near edge structure (XANES) and extended X-ray absorption fine structure (EXAFS) analysis were carried out (FIGS. 3A and 3B). Mo, MoO₃, MoS₂, Co₃S₄/MoS₂ and G-SHELL were analysed for the investigation of neighbouring atom around Mo in G-SHELL, whereas Co₃S₄/MoS₂ and G-SHELL were analysed to examine the neighbouring atom around Co. Since the bonding length of Mo—C along the c axis in G-SHELL is smaller than that of Mo—Mo bond along the c axis in MoS₂, it can be anticipated that there should be more scattering including both single scattering and multiple scattering. The intensity of absorption, which is known to be affected by multiple scattering in XANES region, was notably higher for G-SHELL than Co₃S₄/MoS₂ as expected.

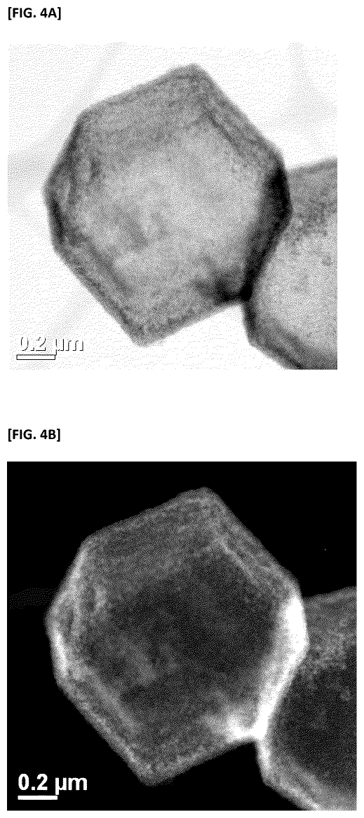

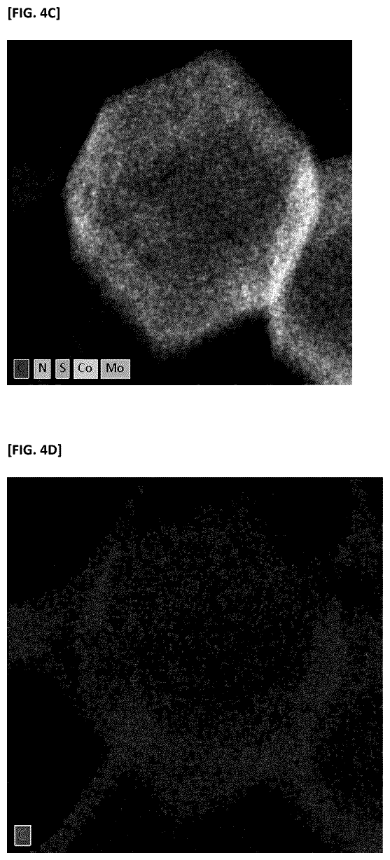

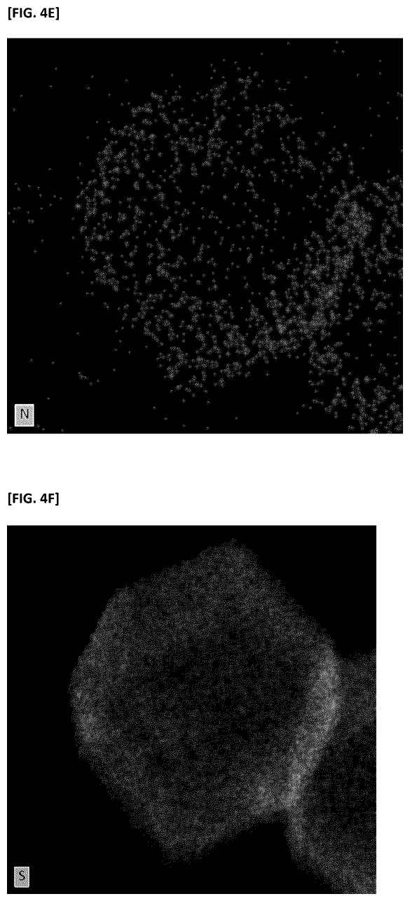

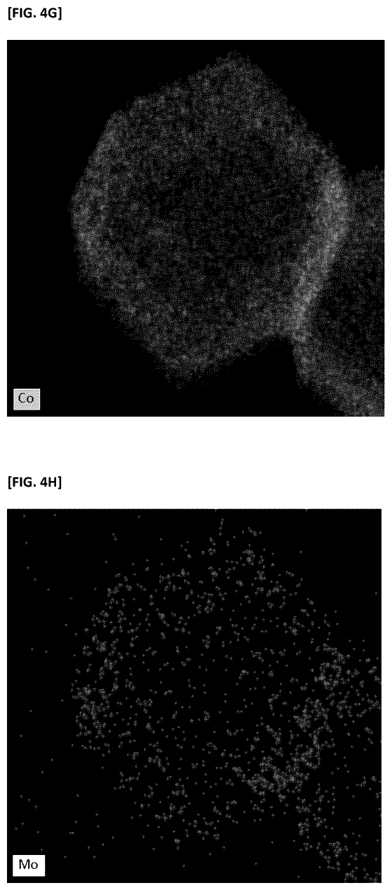

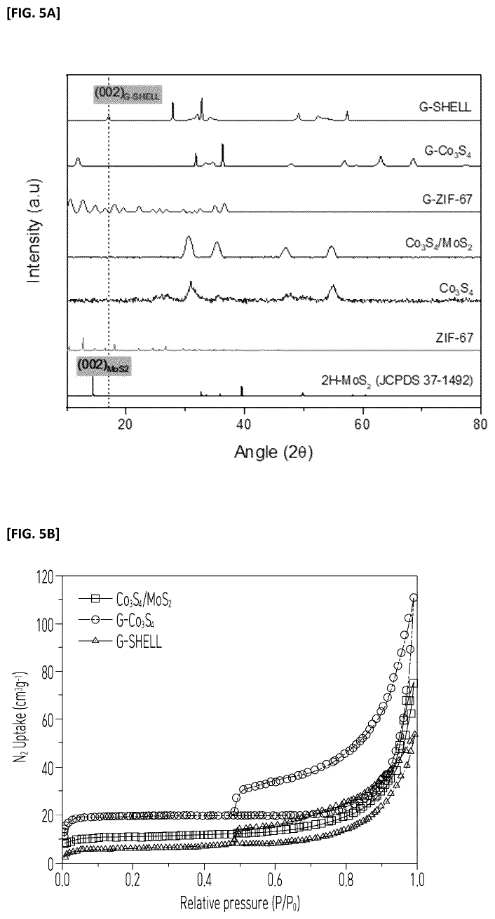

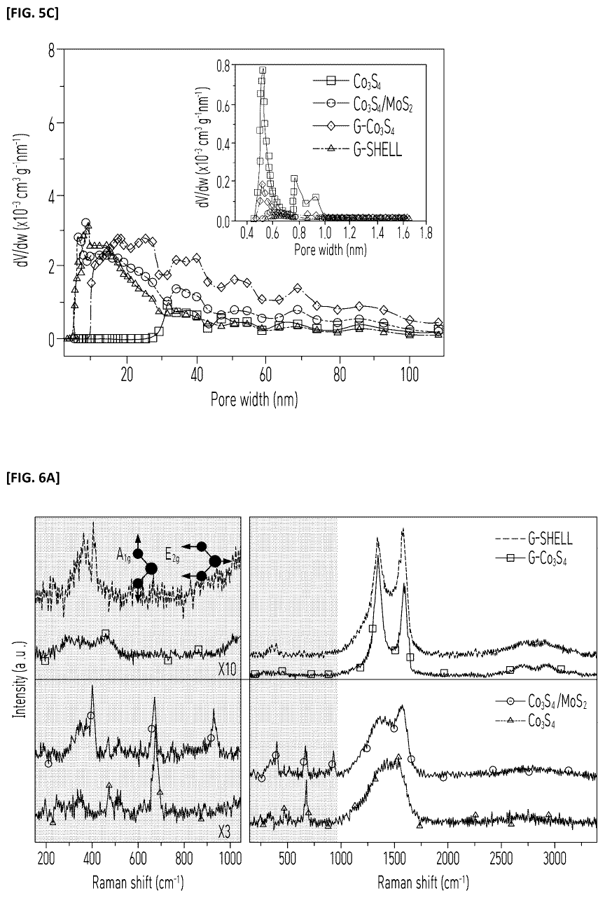

Furthermore, the existence of graphene—MoS₂ sandwiched structure was proved by analysing the Fourier transformation of k²-weighted EXAFS patterns (FIG. 4A to FIG. 4H) and the wavelet transformation of EXAFS patterns (FIG. 3B and FIG. 3C). In accordance with our anticipation, a peak that has the same distance (5.2 Å) as the d-spacing of MoS₂-Graphene (002) shown in XRD and HRTEM could be identified (FIG. 3B).

By investigating the wavelet transformation of EXAFS using Morlet wavelet for Mo K edge of the G-SHELL, two maximum peaks were identified (FIG. 3B). One peak at the bottom-right side of the plot corresponds to Mo—Mo bond whereas the other peak at middle-right side corresponds to Mo—C bond. In order to achieve the Mo—C distance of 5.2 Å, it is thought that the sandwiched Graphene layer exists in tilted position with MoS₂ layer to maximize the Mo—C alignment.

As a result of analysis Co K edges of Co, Co₃S₄/MoS₂ and G-SHELL examined by XANES and EXAFS, similar to the XANES spectrum of Mo, the intensity of G-SHELL is the highest among three samples, indicating that the number of scatterings around Co was highest in G-SHELL which could be attributed to heterojunction. In general, the EXAFS spectra of Co₃S₄/MoS₂ and G-SH ELL showed similar peak distribution, indicating that heterojunction is formed in both cases. Therefore, the difference in structural/electrochemical properties between Co₃S₄/MoS₂ and G-SHELL should be attributed to difference in Graphene sandwiched structure. Subsequently, wavelet transformation analysis of G-SHELL was conducted, and the Co—S peak was clearly distinguished.

### Result 4. Brunauer-Emmit Teller (BET) Theory

As a result of the analysis of N₂ adsorption-desorption isotherms, micropores in G-SHELL was categorized by analyzing adsorption-desorption properties of G-SHELL and it is determined as type IV isotherm because of its four inflection points and its unique shape of hysteresis. Furthermore, the hysteresis of G-C₃S₄ and G-SHELL could be classified as H3 type hysteresis since G-SHELL exhibited a type IV isotherm and the slope of the desorption curve of G-SHELL was clearly different from the adsorption curve. Given that H3-type hysteresis is found in substances with flaky particles, it can be inferred that graphene is responsible for this hysteresis behavior. This is supported by the fact that the isotherm curve differs significantly from those of samples without graphene.

### Result 5. Raman Spectrum

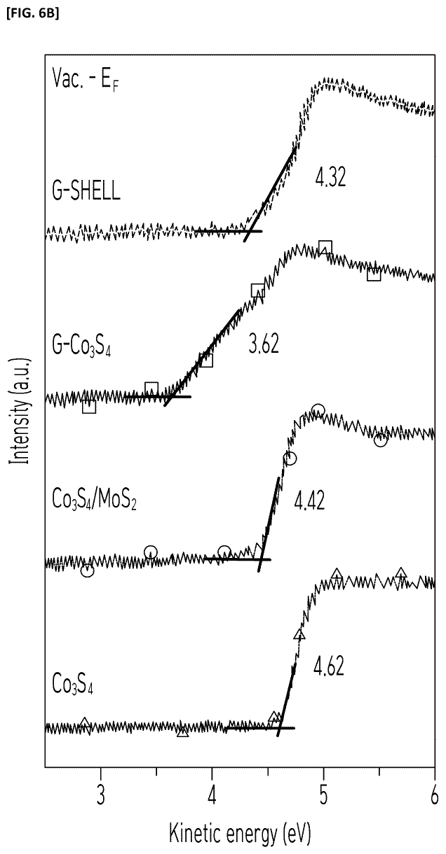

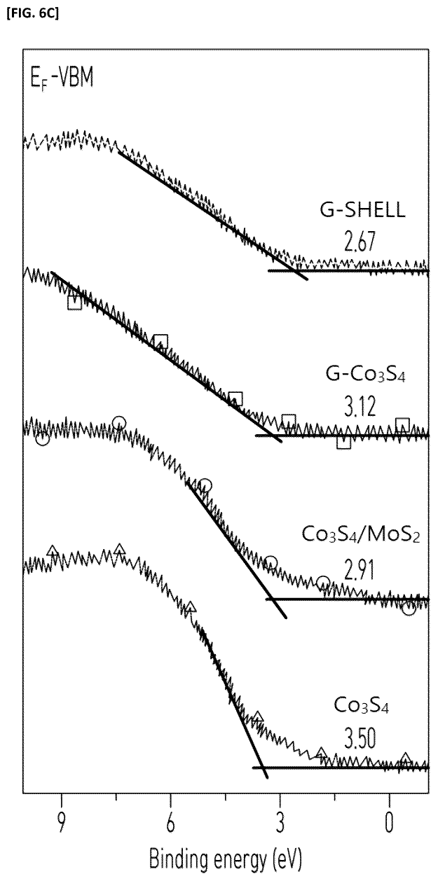

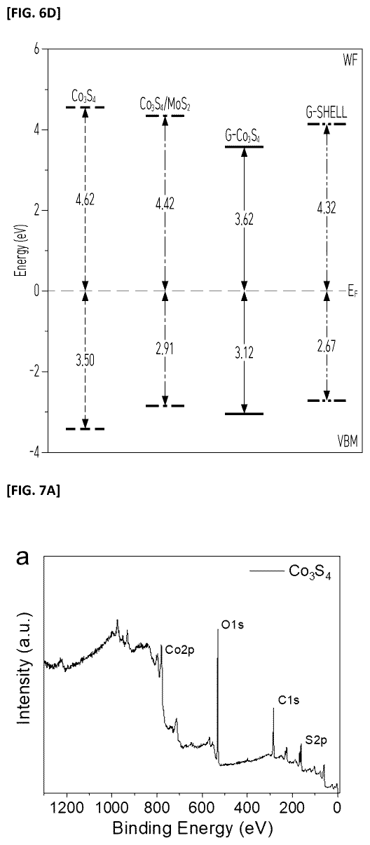

Raman spectra (FIG. 6A) for Co₃S₄/MoS₂/graphene heterostructures exhibited the peaks at 185 cm⁻¹ (A_{g}), 341 cm⁻¹ (E_{g}), 464 cm⁻¹ (F_{2g}), 510 cm⁻¹ (S—S), and 660 cm⁻¹ (A_{1g}). F_{2g} corresponds to the asymmetric bending vibration of the tetrahedral Co²⁺—S bond in Co₃S₄, whereas A_{1g} is the symmetric stretching of the tetrahedral Co²⁺—S bond. Compared to Co₃S₄ and Co₃S₄/MoS₂, the A_{1g} peak showed a blue shift, indicating that the interaction between Co—S(Co²⁺) species had increased. The typical in-plane E_{12g} (˜380 cm⁻¹) and out-of-plane A_{1g} (˜404.9 cm⁻¹) vibration modes of the MoS₂ layer were measured. The interesting peak located at 960 cm⁻¹ could be attributed to Co—MoSₓ heterostructure. G-SHELL showed a larger distance of 28.54 cm⁻¹ between E_{12g} and A_{1g} compared to 26.67 cm⁻¹ in Co₃S₄/MoS₂, consistent with that attributed to the MoS₂ out-of-plane vibration restriction. This strong Co₃S₄ peak appeared to be diminished for G-Co₃S₄ and G-SHELL; however, a broad peak of Co— MoSₓ centered at the same location was observed. The reduced size of Co₃S₄ and the increased surface coverage of Co₃S₄ by graphene and MoS₂ layers resulted in a broad peak characteristic. Also, the peak intensity ratios (ID/IG) of 0.876, 0.798, 1.34, and 0.96 corresponding to Co₃S₄, Co₃S₄/MoS₂, G-Co₃S₄, and G-SHELL were used to determine the degree of graphitization. Both H-CMS and G-H-CMS showed a lower peak intensity ratio than H—CS and G-H—CS owing to the added reduction of graphitic carbon caused by their additional hydrothermal synthesis procedure performed at a higher temperature (200° C.). Additionally, the existing defects were believed to be caused by metal-sulfur bonding (i.e., MoS₂ of G-SHELL) formation and graphene interlayer-induced high strain. In G-SHELL, the abundant heterojunction-generated interfacial electric field (IEF) was considered to cause H*, O*, OH*, and OOH* species adsorption and accelerate the transformation of intermediates at catalytically active sites.

### Result 6. Ultraviolet Photoelectron Spectroscopy (UPS) Analysis

Ultraviolet photoelectron spectroscopy (UPS) analysis revealed the valence band maximum (VBM) edges of 3.50, 2.91, 3.12, and 2.67 eV for Co₃S₄, Co₃S₄/MoS₂, G-Co₃S₄, and G-SHELL, respectively, as shown in FIG. 6B to FIG. 6D. All materials had VBM values less than the Fermi energy level, indicating that they were all semiconductors. The work function (W) is the smallest amount of energy required for an electron to escape from the Fermi level to the vacuum level, and it can be calculated from the following equation, S3:

$$E = hv - {E}_{c utoff} \qquad [ S 3 ]$$

In S3, hv is the incident photon energy (eV) and E_{cutoff} is the normalized secondary electron cutoff energy.

The calculated work functions of Co₃S₄, Co₃S₄/MoS₂, G-Co₃S₄, and G-SHELL were 4.62, 4.42, 3.62, and 4.32 eV, respectively. Electrons can easily move from Co₃S₄ to MoS₂ and the graphene interlayer. Thus, the electrons from Co₃S₄ and the holes from MoS₂/graphene affect the OH* adsorption energy for OER/ORR (or H* for HER) and downshift the overpotential of each reaction. The interface between two different semiconductors can tune the band level and help electrons migrate from high to low levels until the system reaches equilibrium. Because of the high degree of overlapping in energy levels between Co₃S₄ and MoS₂/graphene, an IEF is built up to drive electron flow from Co₃S₄ to MoS₂/graphene to attain the equilibrium level. The non-oriented transfer of electrons helps to modulate the charge distribution and promote hydroxide adsorption.

### Result 7. X-Ray Photoelectron Spectroscopy (XPS) Analysis

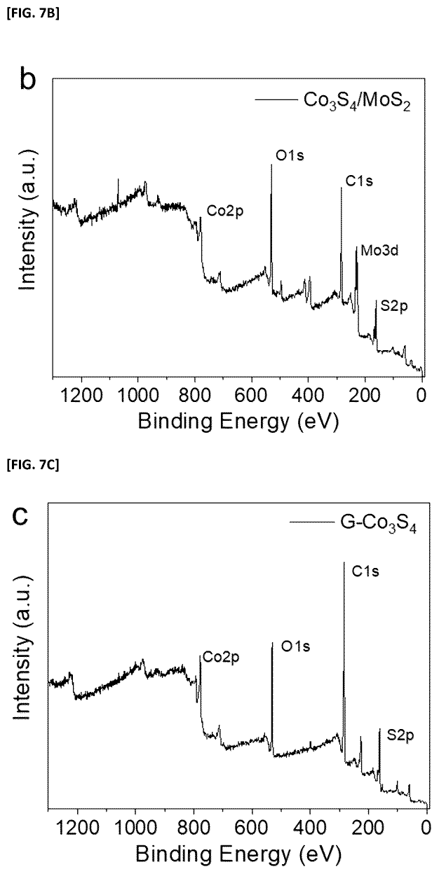

The X-ray photoelectron spectroscopy (XPS) survey scan of G-SHELL showed the well-resolved peaks of C, Co, Mo, S, and O species as shown in FIG. 7A to FIG. 7D. The FIG. 8 supports the existence of bridging S₂²⁻ (denoted as M-S in the spectrum, including Co—S, Mo—S, and edge sulfur) and terminal S₂²⁻ (S 2p_{3/2} and S 2p_{1/2}) as indicated by three major peaks located at 164.1, 162.9, and 161.7 eV.

The S 2p_{3/2} peak shifted to a higher binding energy from 161.2 to 162.0 and 162.3 eV and then slightly decreased to 161.95 eV in Co₃S₄, Co₃S₄/MoS₂, G-Co₃S₄, and G-SHELL. Co₃S₄/MoS₂ and G-SHELL (Containing Co₃S₄/MoS₂/graphene) have similar binding energies with a similar fraction of the S 2p_{3/2} ratio. This suggests that the terminal S species are more strongly bonded to graphene than to MoS₂, and G-SHELL can form a sandwich structure of Co₃S₄/MoS₂/graphene.

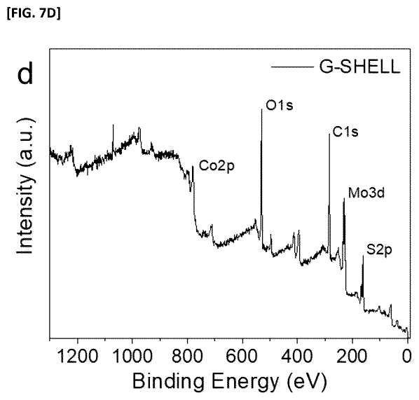

FIG. 9 shows Co 2p spectra with two pairs of satellite peaks (778.5 and 793.3 eV) and spin-orbit doublets (781.4 and 797.5 eV) for Co³⁺ 2p_{3/2} and Co³⁺ 2p_{1/2} and Co²⁺ 2p_{3/2} and Co²⁺ 2p_{1/2}, respectively. The coexistence of Co²⁺ and Co³⁺ is explained by the chemical state of the tetrahedral (CO²⁺) and octahedral (Co³⁺) sites in Co₃S₄. The position of the Co²⁺ peak in H—CS and H-CMS exhibited a blue shift from 781 to 781.5 eV and a red shift from 781.7 to 781.45 eV in G-CS and G-SHELL. This finding suggests that Co species form stronger bonds with graphene than with MoS₂ as demonstrated by G-SHELL. Another method for deciphering the bonding nature using the XPS data is to compute the areal ratio between Co²⁺ and Co³⁺ peaks (CO²⁺/Co³⁺). Although the samples containing Co₃S₄ attached to MoS₂ (Co₃S₄ or G-SHELL) exhibited a high areal ratio of Co²⁺/Co³⁺, the value dropped dramatically when attached to graphene (G-Co₃S₄). If a heterojunction formed between Co₃S₄ and MoS₂, an IEF was generated and the areal ratio increased in H-CMS and G-SHELL, whereas only the electron-donating behavior of Co₃S₄ to graphene was observed in G/H—CS. This high Co²⁺/Co³⁺ ratio for G-SHELL could change the Fermi level to achieve the optimal binding energy with intermediate species (e.g., OH_{ads}), thereby allowing enhancement in OER properties and overcoming sluggish ORR kinetics.

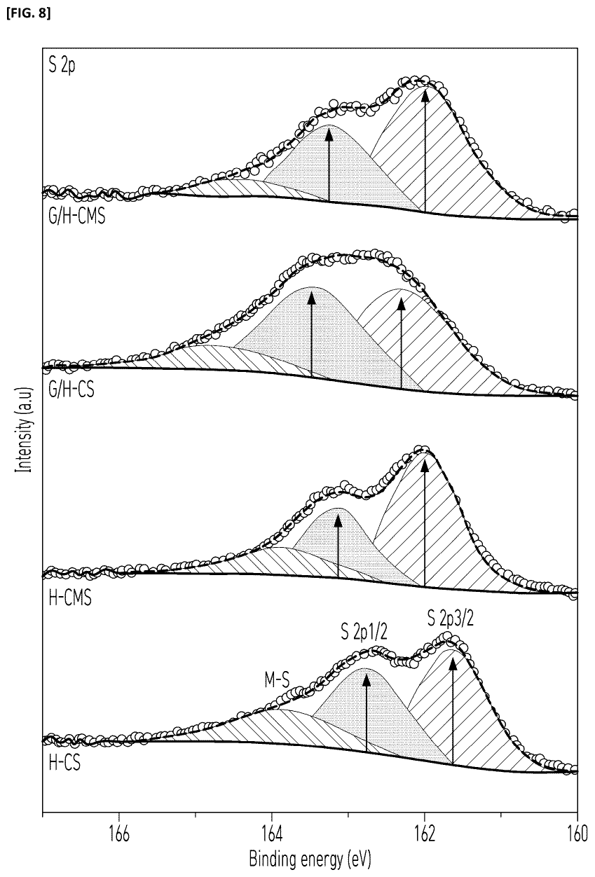

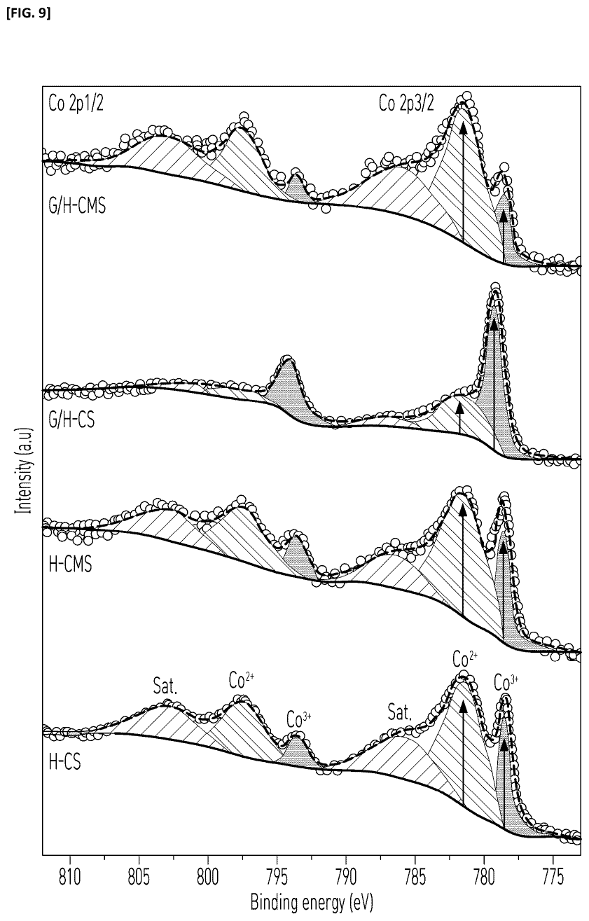

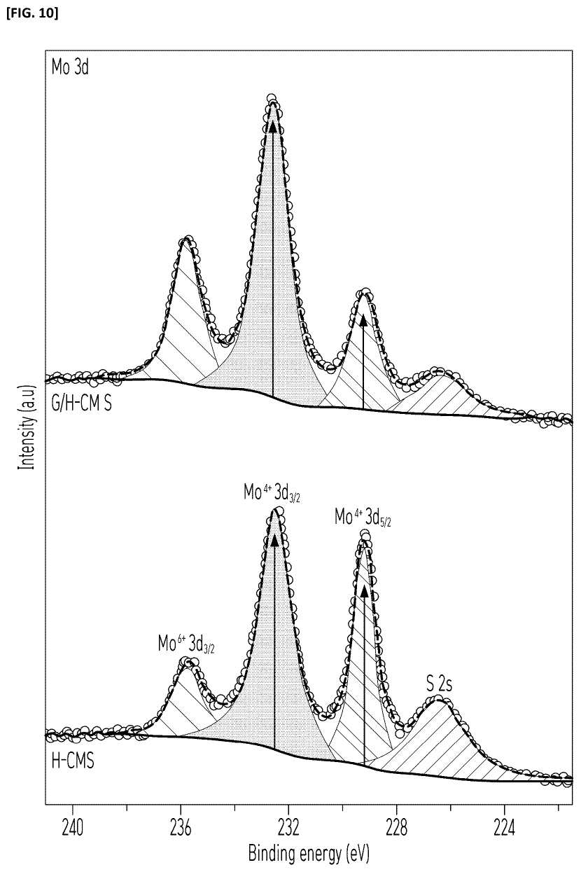

As a result of a comparison of the Mo 2d spectra of H-CMS and G-SHELL, which shows the typical peaks of Mo 3d_{s/2} (228.8 eV), Mo 3d_{3/2}(231.8 eV), and S 2s (226.0 eV), unlike the peaks of Mo 3d_{s/2} and Mo 3d_{3/2}, which have a valence of 4 and represent MoS₂, the doublets at 230.5 eV and 232.6 eV represent the peaks for Mos⁵⁺ and Mo⁶⁺ respectively (FIG. 10). Compared to H-CMS, the intensity of the Mo⁶⁺ peak and its position are both higher for G-SHELL. This significant increase in Mo valence confirms the formation of a heterojunction between MoS₂ and Co₃S₄ as well as electron density donation to the sandwiched graphene. This high-valence Mo6+ can be reduced to a lower valence state, which helps to accelerate the OER performance.

The deconvoluted C 1s peak, shows the characteristics of sp²-hybridized C—C/C═C (284.1 eV), C—S(˜285.6 eV), and C—O (˜286.6 eV) bonds. This confirms that the high sp²-dominance of G-SHELL contributes to resulting in high electric conductivity.

### Result 8. Performance of Trifunctional Catalyst with Co₃S₄, Co₃S₄/MoS₂, G-Co₃S₄ and G-SHELL

Cyclic voltammetry (CV) measurements were performed in 0.1 M KOH under the saturated O₂ condition without rotation in a conventional three-electrode rotating disk electrode (RDE) system to determine the electrocatalytic performance of G-SHELL. The characteristic oxygen-reduction peak for G-SHELL can be clearly seen at 0.8 V, indicating the apparent electrocatalytic ORR activity.

As the FIG. 11A shows the ORR polarization curves obtained by linear sweep voltammetry measurements ranging from 1.1 to 0.2 V vs. RHE at 1600 rpm, the onset potential (Eₒₙₛₑₜ, 0.89 V) of G-SHELL was comparable with that of Pt/C, and its half-wave potential (E_{1/2}) and limited current density (0.72 V, 3.9 mA cm⁻²) were found to be similar to those better than those of Co₃S₄(0.64 V, 2.5 mA cm⁻²), Co₃S₄/MoS₂ (0.67 V, 3.1 mA cm⁻²), and G-Co₃S₄(0.71 V, 3.3 mA cm⁻²).

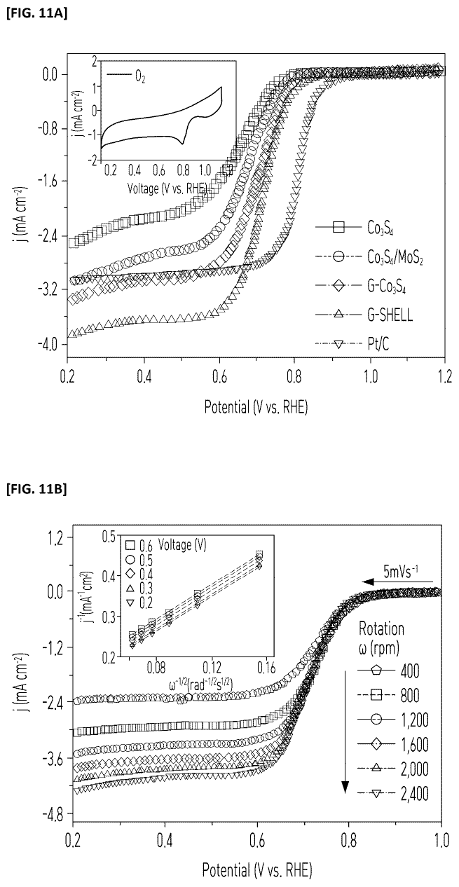

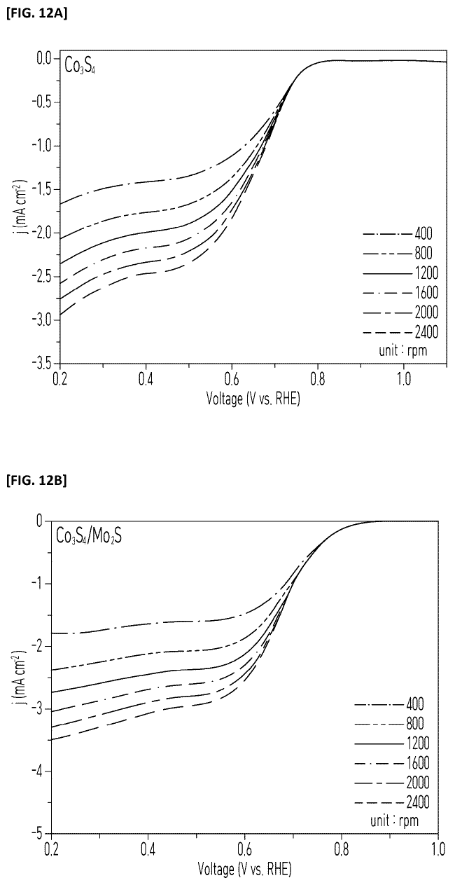

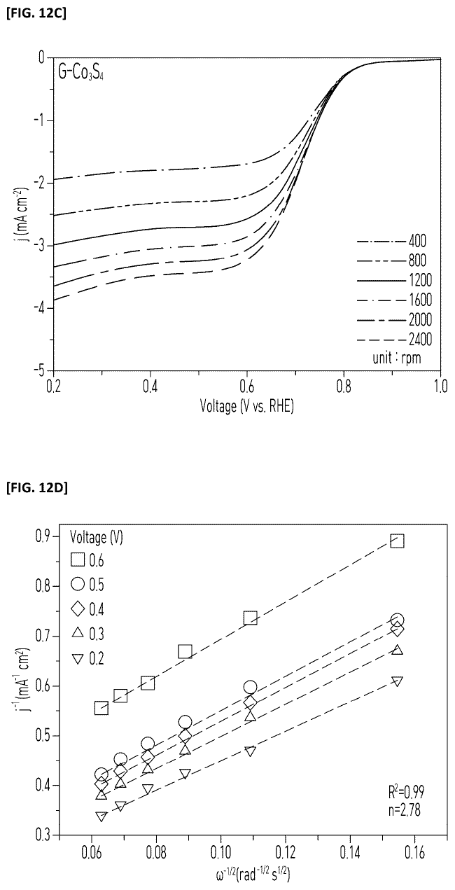

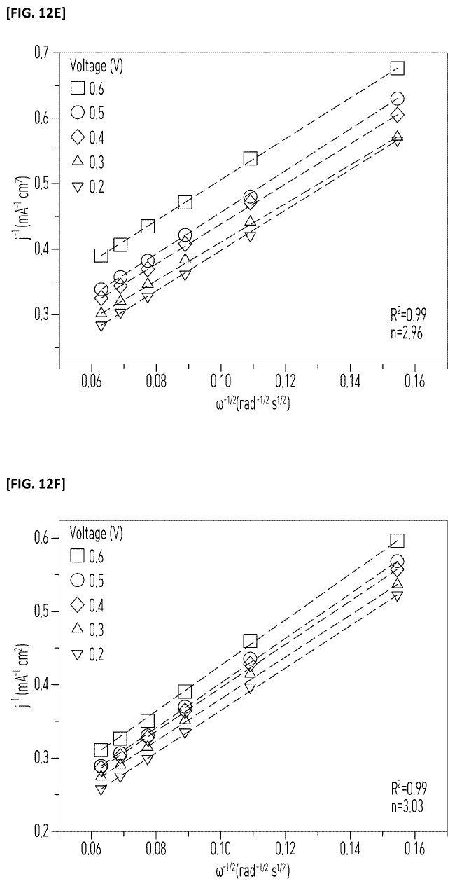

Furthermore, RDE measurements were performed on the G-SHELL catalyst at different rotating speeds, and Koutecky-Levich (K-L) plots (FIG. 12A to FIG. 12F) were obtained from the corresponding polarization curves (FIG. 11B and the inset of FIG. 11B) for Co₃S₄, Co₃S₄/MoS₂, and G-Co₃S₄. Because of the shortened diffusion length at higher speeds, the current densities increased in lockstep with the increasing rotating speed. The reserve square root of the rotation speed and the reserve limiting current density are well linearized in K-L plots. In addition, the electron transfer number (denoted as n) of G-SHELL for ORR was calculated. The average n value of G-SHELL was found to be 4.2, confirming a four-electron pathway in the ORR process according to the fitted potential range from 0.6 to 0.2 V, whereas those of Co₃S₄, Co₃S₄/MoS₂, and G-Co₃S₄ were 2.8, 3.0, and 3.75, respectively.

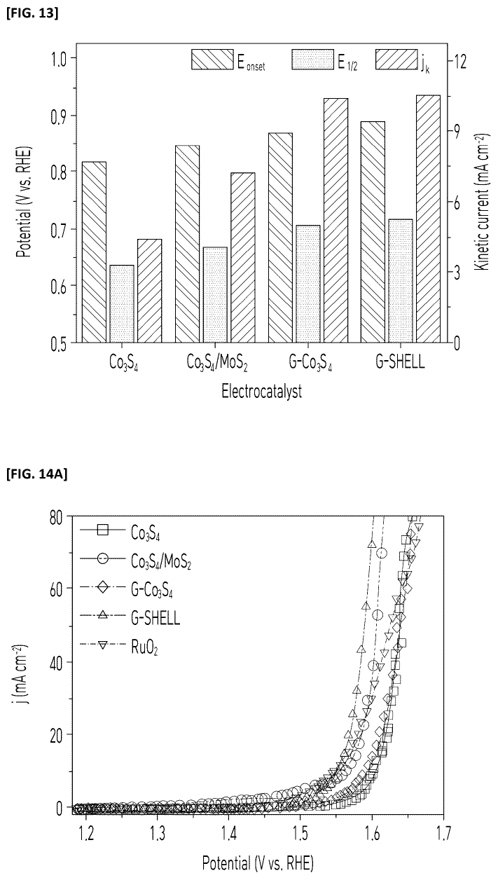

In FIG. 13, the average kinetic current density (jₖ) of G-SHELL was measured to be 10.5 mA cm-2. The ORR kinetics of G-SHELL were further confirmed by electrochemical impedance spectroscopy (EIS) analysis at 0.6 V vs. RHE with a rotation speed of 1600 rpm. The charge transfer resistance of G-SHELL shows a twofold lower than that Pt/C, indicating the improved reaction kinetics enabled by the tuned electronic structure of G-SHELL.

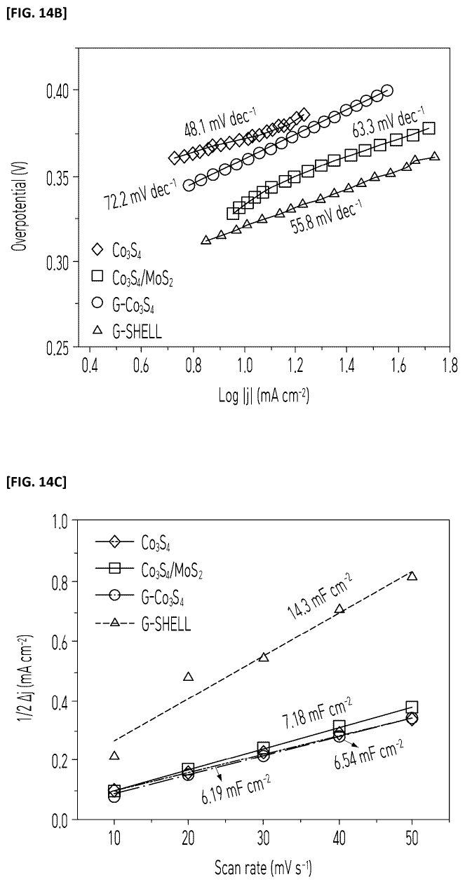

Moreover, we tested the OER and HER electrocatalytic performances of G-SHELL in 1 M KOH electrolyte to demonstrate its multifunctionality. FIG. 14A shows that G-SHELL affords excellent OER activity with an overpotential of 320 mV at a current density of 10 mA cm⁻², which is superior to the overpotential of 354 mV for the outstanding noble metal OER catalyst RuO₂. Additionally, G-SHELL outperformed recently reported advanced non-noble metal-based OER catalysts. The corresponding Tafel slope for G-SHELL (FIG. 14B) was fitted to be 55.8 mV dec⁻¹, indicating fast OER kinetics superior to those of Co₃S₄/MoS₂ (63.3 mV dec⁻¹) and RuO₂ (59.7 mV dec⁻¹).

FIG. 14C shows that G-SHELL has a higher C_{dl} value of 14.3 mF cm⁻² compared to Co₃S₄(6.19 mF cm⁻²), Co₃S₄/MoS₂(6.54 mF cm⁻²), and G-Co₃S₄(7.18 mF cm⁻²). In addition, we discovered that G-SHELL exhibited superior HER activity in 1 M KOH electrolyte.

Because catalytic activity also depends on the number of active sites that can be attributed to the electrochemical active surface area (ECSA), we measured the double-layer capacitance (C_{dl}), which is the key determining factor for ECSA. The C_{dl} of G-SHELL was explored using CV curves at increasing scan rates under a non-Faradaic potential window (0.925-1.025 V vs. RHE).

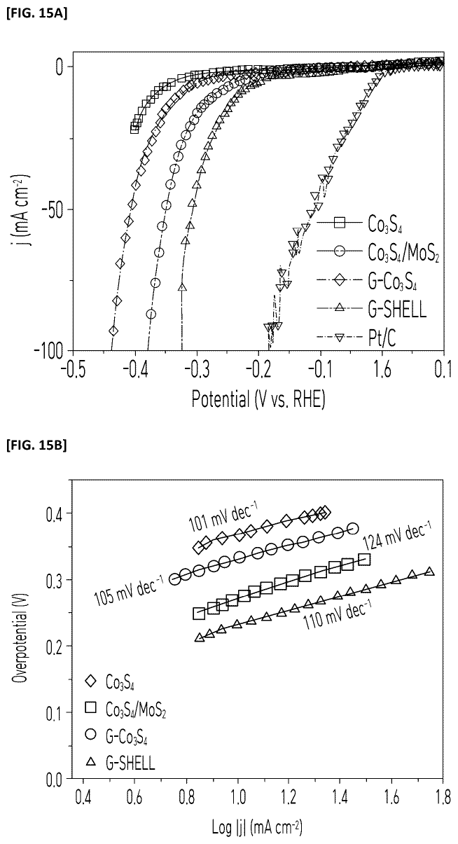

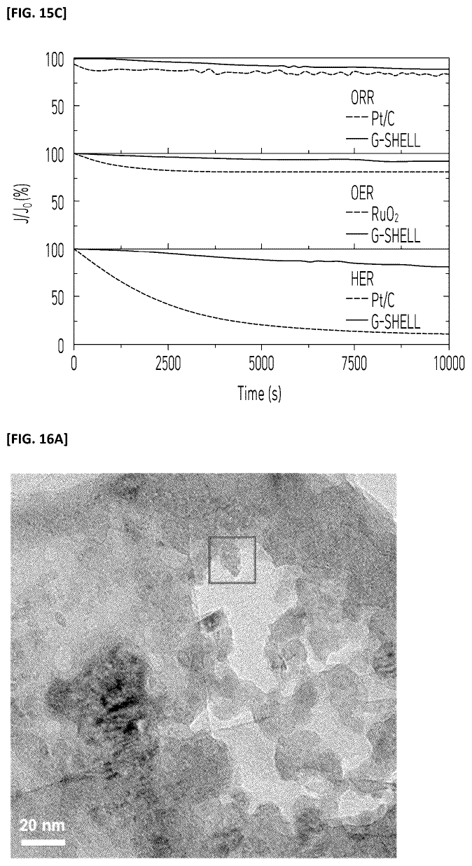

G-SH ELL exhibited a low overpotential of 220 mV at 10 mA cm⁻² and a low Tafel slope (110 mV dec-1) as shown in FIG. 15A and FIG. 15B, which are remarkable values compared to those of previous heterojunction-based catalysts. Apart from superior electrocatalytic activities, the G-SHELL catalyst outperformed commercial catalysts in terms of long-term durability under ORR, OER, and HER (FIG. 15C). In FIG. 16A and FIG. 16B, after immersing in 1 M KOH over 10 days, surface was partially oxidized, however, the hollow structures and crystallinities of G-SHELL was well maintained. Furthermore, the methanol tolerance of G-SHELL showed little to no changes, whereas Pt/C showed significant degradation, which could be attributed to the improved cycling stability when applied in a Zn-air battery.

### Result 9. Zn-Air Battery Performance Evaluation

G-SHELL is used as a trifunctional cathode material in a rechargeable ZAB and a ZAB-driven water-splitting device is created. A commercial standard mixture (Pt/C and RuO₂ in the same weight ratio) was tested as the cathode for comparison. The stable open circuit voltage (OCV) of the G-SHELL-based ZAB was 1.43 V, which was higher than that of the Pt/C+RuO₂-based cell (1.41 V). Thanks for high alkaline stability of G-SHELL-based ZAB cell, The OCV was maintained over 187 h, comparing with Co₃S₄/MoS₂(176 h), G-Co₃S₄(183 h), and highly unstable Co₃S₄(after 0.65 h, fluctuating behavior was observed).

The smaller voltage gap between the discharge and charge polarization curves (FIG. 17A) indicates the excellent rechargeable capability of the G-SHELL-based ZAB cell. FIG. 17B depicts the discharge polarization and power density curves. The peak power density of the G-SHELL-based ZAB was 275.8 mW cm⁻², which was significantly higher than that of the Pt/C+RuO₂-based cell (202.6 mW cm⁻²) and recently reported rechargeable ZABs.

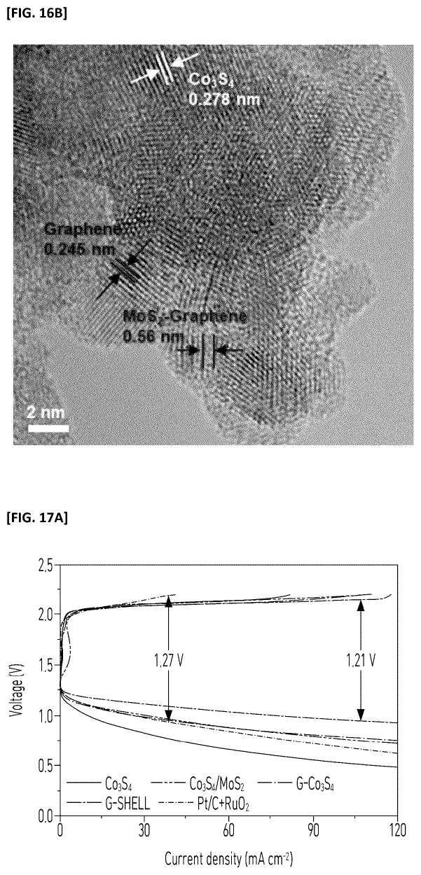

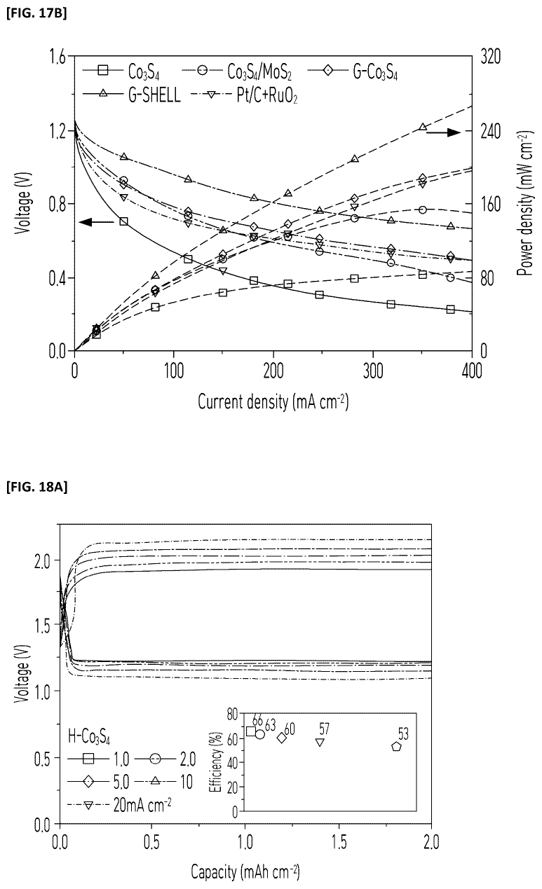

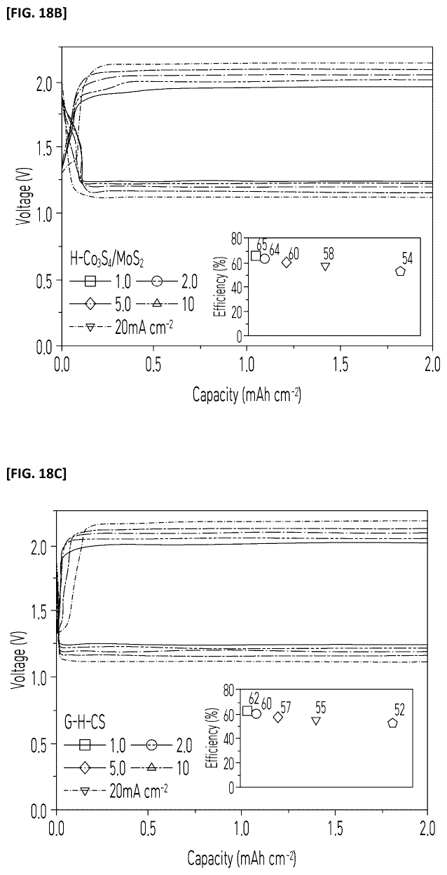

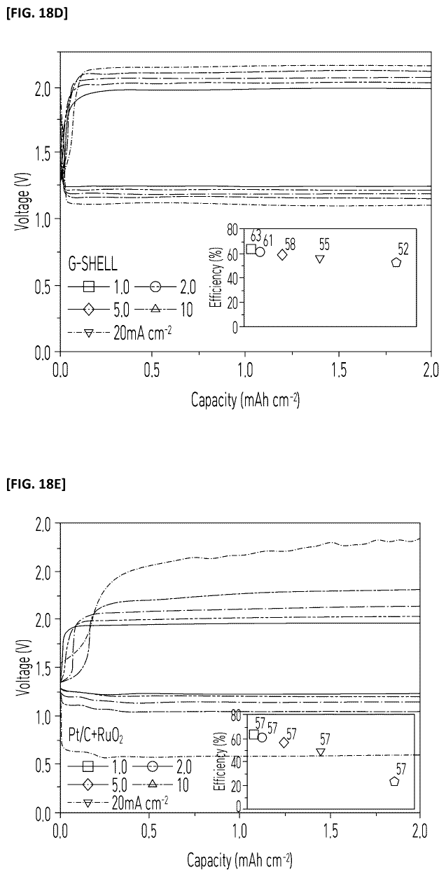

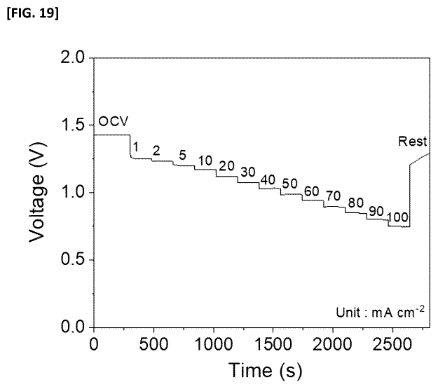

Additionally, we tested the rate capability of the G-SHELL-based ZAB further by increasing the current density from 0.1 to 20 mA cm⁻² in FIG. 18A to FIG. 18E. The round-trip efficiency ranged from 63% to 52%, which was comparable with that of Pt/C+RuO₂ (63% to 23%). Moreover, G-SHELL-based ZAB shows stable discharge voltage over 100 mA cm-2(FIG. 19).

G-SHELL based ZAB exhibited long-term stability over 100 cycles at a current density of 10 mA cm-2, with 10 minutes for each charge and discharge process. A small voltage gap of 0.95 V was maintained during cycles with high round-trip efficiency of 54.7%, superior to the corresponding values for the Pt/C+RuO₂-based cell (1.12 V, 50.1%).

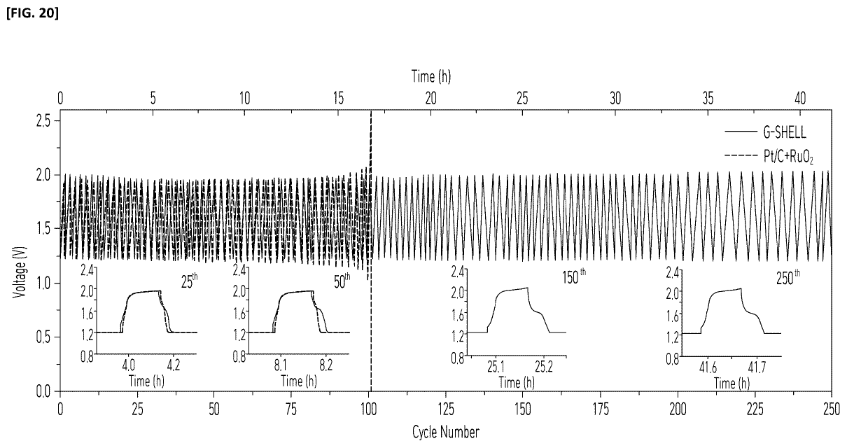

As demonstrated in FIG. 20, even after 250 cycles of operation (41.6 hours), the G-SHELL-based cell displayed negligible performance fading, but the Pt/C+RuO₂-based cell caused a fast degradation by raising the voltage gap to 0.95 V after the 100 cycles.

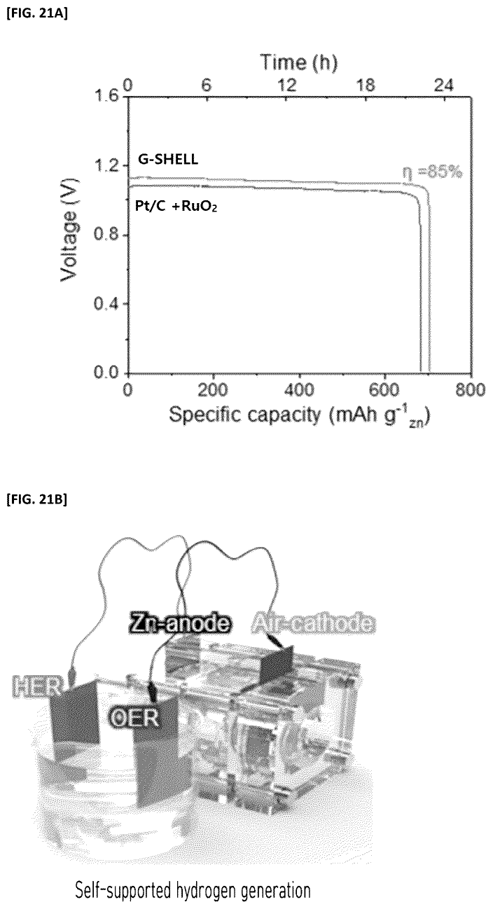

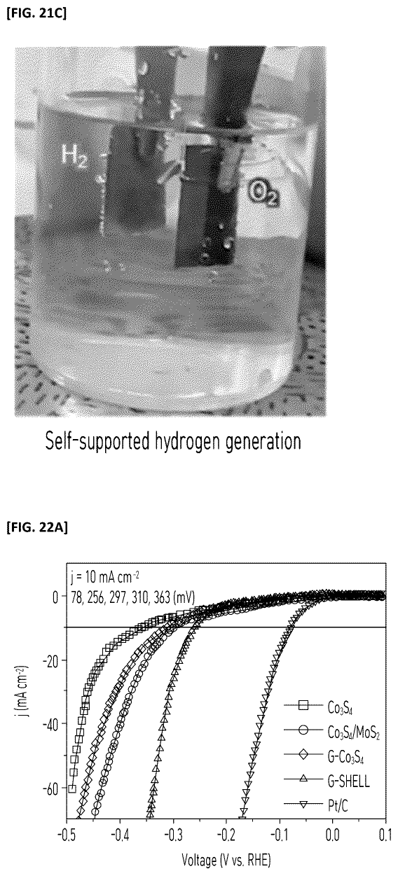

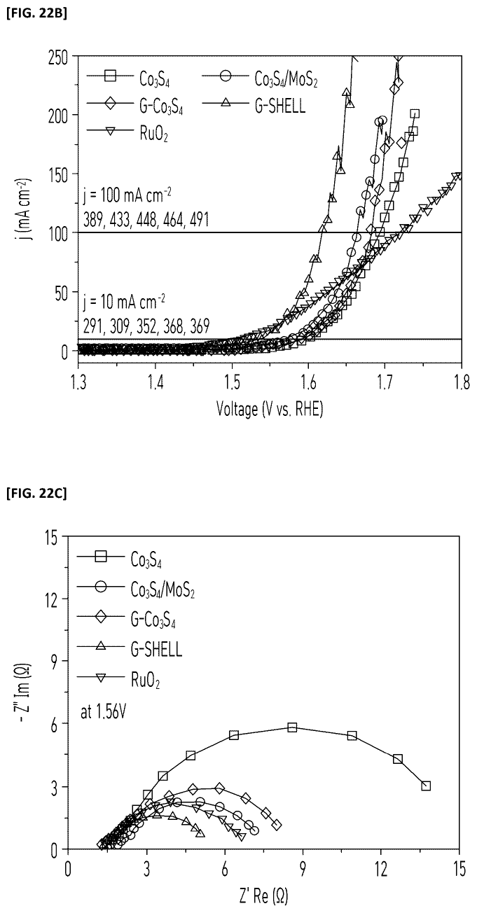

FIG. 21A shows that the G-SHELL-based cell achieved a high specific discharge capacity of 703.2 mAh g⁻¹ at 10 mA cm⁻² and an energy density of 796.8 Wh kg⁻¹ based on the consumed Zn metal, close to the theoretic values of ZAB (820 mAh g⁻¹ and 1084 Wh kg⁻¹). FIG. 21B shows that G-SHELL based ZAB cell has a high energy density and power density with the Ragone plots for G-SHELL and that G-SHELL based ZAB cell can realize a highly efficient self-driven water splitting system. A self-driven water-splitting system using two ZABs solely based on G-SHELL was assembled, as demonstrated in FIG. 21C, in which H₂ and O₂ bubbles were clearly visible on each electrode surface.

Besides, the high hydrophilicity of G-SHELL was shown to result in a lower surface energy between the electrode and electrolyte, which contributes to enhancing reaction intermediate adsorption and quick bubble removal. Water electrolyzer coated on carbon paper was assembled by three-electrode system, which required small overall over potential of a voltage of only 0.56 V to achieve a current density of 10 mA cm⁻². Furthermore, at 1.56V vs. RHE, the G-SHELL has a reduced charge transfer resistance of 3.63Ω compared to RuO₂ (5.10Ω). This demonstrates that the relatively slow kinetics of OER in water splitting was alleviated.

It would be understood by a person with ordinary skill in the art that various changes and modifications may be made based on the above description without changing technical conception and essential features of the present disclosure. Thus, it is clear that the embodiments are illustrative in all aspects and do not limit the present disclosure. The scope of the present disclosure is defined by the following claims. It shall be understood that all modifications and embodiments conceived from the meaning and scope of the claims and their equivalents are included in the scope of the present disclosure.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A trifunctional catalyst, comprising:
a polyhedral Co₃S₄ layer,
a first MoS₂ layer and a second MoS₂ layer located on the Co₃S₄ layer, and
a graphene layer located between the first MoS₂ layer and the second MoS₂ layer.

2. The catalyst of claim 1,
wherein a diameter of the trifunctional catalyst is from 90 nm to 100 nm.

3. The catalyst of claim 1,
wherein the trifunctional catalyst has a hollow structure.

4. The catalyst of claim 1,
wherein heterojunctions are formed, respectively,
between the Co₃S₄ layer and the first MoS₂ layer,
between the first MoS₂ layer and the graphene layer, and
between the graphene layer and the second MoS₂ layer.

5. The catalyst of claim 1,
wherein the trifunctional catalyst is used for an oxygen evolution reaction (OER), a hydrogen evolution reaction (HER), and/or an oxygen reduction reaction (ORR).

6. A method of obtaining trifunctional catalyst, comprising:
a process (a) of growing ZIF-67 on a surface of graphene oxide;
a process (b) of sulfurizing the ZIF-67 to obtain a G-Co₃S₄ structure containing the graphene oxide and the Co₃S₄ layer; and
a process (c) of growing a MoS₂ layer on the G-Co₃S₄ structure to obtain the trifunctional catalyst of the claim 1.

7. The method of claim 6,
wherein the method is performed through a one-pot process.

8. The method of claim 6,
wherein the process (b) is performed at a temperature of from 0° C. to 200° C.

9. The method of claim 6,
wherein the process (b) is performed for from 1 hour to 7 hours.

10. The method of claim 6,
wherein the process (c) is performed at a temperature of from 100° C. to 300° C.

11. The method of claim 6,
wherein the process (c) is performed for from 5 hours to 15 hours.

12. An air electrode for a metal-air battery, comprising the trifunctional catalyst of claim 1.

13. The air electrode for a metal-air battery of claim 12,
wherein the metal-air battery is a zinc-air battery, an aluminum-air battery, a magnesium-air battery, or a lithium-air battery.

14. A metal-air battery comprising the electrode of the claim 12; an anode containing a metal; and an electrolyte.

15. A water splitting system, comprising a trifunctional catalyst,
wherein the trifunctional catalyst comprises a polyhedral Co₃S₄ layer; a first MoS₂ layer and a second MoS₂ layer on the Co₃S₄ layer; and a graphene layer located between the first MoS₂ layer and second MoS₂ layer.

16. The water splitting system of claim 15,
wherein a power supply device used in the water splitting system is a metal-air battery comprising the air electrode comprising the catalyst.

17. The water splitting system of claim 15,
wherein an anode and/or a cathode of the water splitting system contain the catalyst.

18. The water splitting system of claim 15,
wherein the water splitting is performed in alkaline conditions.

19. The water splitting system of claim 15,
wherein the water splitting system comprises a power supply device including a metal-air battery; an anode for water splitting; and a cathode for water splitting, and an electrolyte,
wherein at least one selected from an air electrode of the metal-air battery, the anode for water splitting, and the cathode for water splitting contain the catalyst.

20. The water splitting system of claim 19,
wherein, when the air electrode of the metal-air battery, the anode for water splitting, and the cathode for water splitting contain the catalyst, an oxygen reduction reaction, an oxygen evolution reaction, and a hydrogen evolution reaction occur in the air electrode, the anode for water splitting, and the cathode for water splitting, respectively.
